(19) United States
(12) Patent Application Publication
(10) Pub. No.: US 2013/0297657 A1
(43) Pub. Date: Nov. 7, 2013

(54) Apparatus and Method for Forming and Using a Tree Structured Database with Top-Down Trees and Bottom-Up Indices

(71) Applicants: Gajanan Chinchwadkar, Fremont, CA (US); Christopher Lindblad, Berkeley, CA (US); Mary Holstege, Cupertino, CA (US)

(72) Inventors: Gajanan Chinchwadkar, Fremont, CA (US); Christopher Lindblad, Berkeley, CA (US); Mary Holstege, Cupertino, CA (US)

(21) Appl. No.: 13/461,701

(22) Filed: May 1, 2012

(51) Int. Cl. G06F 17/30

(52) U.S. Cl. 707/797; 707/E17.012

(57) ABSTRACT

A method for loading information into a tree structured database includes receiving a document and forming a top-down tree characterizing the document. Leaf nodes in the top-down tree are identified. Bottom-up indices are formed for the leaf nodes, where the bottom-up indices characterizes paths from selected leaf nodes to a root node of the top-down tree. The top-down tree and bottom-up indices are stored as separately searchable entities in the tree structured database.

### FIELD OF THE INVENTION

This invention relates generally to digital information processing. More particularly, this invention relates to techniques for forming and using a tree structured database with top-down trees and bottom-up indices.

### BACKGROUND OF THE INVENTION

A variety of markup languages are known in the art. For example, Extensible Markup Language (XML) is a restricted form of SGML, the Standard Generalized Markup Language defined in ISO 8879 and XML is one form of structuring data. XML is more fully described in “Extensible Markup Language (XML) 1.0 (Second Edition)”, W3C Recommendation (6 Oct. 2000), which is incorporated by reference herein for all purposes [and available at http://www.w3.org/TR/2000/REC-xml-20001006] (hereinafter, “XML Recommendation”). XML is a useful form of structuring data because it is an open format that is human-readable and machine-interpretable. Other structured languages without these features or with similar features might be used instead of XML, but XML is currently a popular structured language used to encapsulate (obtain, store, process, etc.) data in a structured manner.

An XML document has two parts: 1) a markup document and 2) a document schema. The markup document and the schema are made up of storage units called “elements”, which can be nested to form a hierarchical structure. The following is an example of an XML markup document:

<citation publication_date=01/02/2002>

<title>Cerisent XQE</title>
<author>

<last>Pedersen</last>
<first>Paul<?first>

</author>

<abstract>

The Cerisent XQE patent application describes a high-performance.

XML search and database system.

</abstract>

<?citation>

This document contains data for one “citation” element. The “citation” element has within it a “title” element, and “author” element and an “abstract” element. In turn, the “author” element has within it a “last” element (last name of the author) and a “first” element (first name of the author). Thus, an XML document comprises text organized in freely-structured outline form with tags indicating the beginning and end of each outline element. Generally, an XML document comprises text organized in freely-structured outline form with tags indicating the beginning and end of each outline element. In XML, a tag is delimited with angle brackets followed by the tag's name, with the opening and closing tags distinguished by having the closing tag beginning with a forward slash after the initial angle bracket.

Elements can contain either parsed or unparsed data. Only parsed data is shown for the example document above. Unparsed data is made up of arbitrary character sequences. Parsed data is made up of characters, some of which form character data and some of which form markup. The markup encodes a description of the document's storage layout and logical structure. XML elements can have associated attributes in the form of name-value pairs, such as the publication date attribute of the “citation” element. The name-value pairs appear within the angle brackets of an XML tag, following the tag name.

XML schemas specify constraints on the structures and types of elements and attribute values in an XML document. The basic schema for XML is the XML Schema, which is described in “XML Schema Part 1: Structures”, W3C Working Draft (24 Sep. 1999), which is incorporated by reference herein for all purposes [and available at http://www.w3.org/TR/1999/WD-xmlschema-1-19990924]. A previous and very widely used schema format is the DTD (Document Type Definition), which is described in the XML Recommendation.

Since XML documents are typically in text format, they can be searched using conventional text search tools. However, such tools might ignore the information content provided by the structure of the document, one of the key benefits of XML. Several query languages have been proposed for searching and reformatting XML documents that do consider the XML documents as structured documents. One such language is XQuery, which is described in “XQuery 1.0: An XML Query Language”, W3C Working Draft (20 Dec. 2001), which is incorporated by reference herein for all purposes [and available at http://www.w3.org/TR/XQuery].

XQuery is derived from an XML query language called Quilt [described at http://www.almaden.ibm.com/cs/people/chamberlin/quilt.html], which in turn borrowed features from several other languages, including XPath 1.0 [described at http://www.w3.org/TR/XPath.html], XQL [described at Http://www.w3.org/TandS/QL/QL98/pp/xql.html], XML-QL [described at http://www.research.att.com/.about.mfflfiles/final.html] and OQL.

Query languages predated the development of XML and many relational databases use a standardized query language called SQL, as described in ISO/IEC 9075-1:1999. The SQL language has established itself as the linquafranca for relational database management and provides the basis for systems interoperability, application portability, client/server operation, and distributed databases. XQuery is proposed to fulfill a similar role with respect to XML database systems. As XML becomes the standard for information exchange between peer data stores, and between client visualization tools and data servers, XQuery may become the standard method for storing and retrieving data from XML databases.

With SQL query systems, much work has been done on the issue of efficiency, such as how to process a query, retrieve matching data and present that to the human or computer query issuer with efficient use of computing resources to allow responses to be quickly made to queries. As XQuery and other tools are relied on more and more for querying XML documents, efficiency will be more essential.

One problem with data analysis is that qualities of data often need to be determined for classification, comparison or other analytical purposes. A simple quality is whether or not the data contains a specified element. With text documents, an inquiry can be made as to whether a text document contains a string of interest. A search system, for example, can find all files in a corpus that contain a particular string, set of strings, regular expression, etc. It is desirable to avoid the inefficiency of searching an entire corpus for a particular string or path expression. Therefore, there is a need for improved indexing schemes.

### SUMMARY OF THE INVENTION

A method for loading information into a tree structured database includes receiving a document and forming a top-down tree characterizing the document. Leaf nodes in the top-down tree are identified. Bottom-up indices are formed for the leaf nodes, where the bottom-up indices characterizes paths from selected leaf nodes to a root node of the top-down tree. The top-down tree and bottom-up indices are stored as separately searchable entities in the tree structured database.

A method of processing a query to a tree structured database includes resolving a query to path constraints. The path constraints are matched to separately searchable entities of the tree structured database to form matched paths. The tree structured database includes top-down trees characterizing path structures for documents and bottom-up indices for nodes of the path structures for the documents. The bottom-up indices characterize paths from selected leaf nodes to root nodes of the top-down trees.

### BRIEF DESCRIPTION OF THE FIGURES

The invention is more fully appreciated in connection with the following detailed description taken in conjunction with the accompanying drawings, in which:

FIG. 1 is a computer configured to implement operations associated with an embodiment of the invention.

FIG. 2 illustrates the interoperability of different modules associated with an embodiment of the invention.

FIG. 3 illustrates general processing operations associated with an embodiment of the invention.

FIG. 4 is an exemplary markup language document that may be processed in accordance with the disclosed techniques.

FIG. 5 illustrates a tree structure associated with the document of FIG. 4.

FIG. 6 illustrates path processing associated with an embodiment of the invention.

FIG. 7 illustrates a range index configuration table utilized in accordance with an embodiment of the invention.

FIG. 8 illustrates a range index specification that may be utilized in accordance with an embodiment of the invention.

FIG. 9 illustrates a path hash table utilized in accordance with an embodiment of the invention.

FIG. 10 illustrates an element leaf wildcard path vector utilized in accordance with an embodiment of the invention.

FIG. 11 illustrates an element leaf path table utilized in accordance with an embodiment of the invention.

FIG. 12 illustrates an attribute leaf path table utilized in accordance with an embodiment of the invention.

FIG. 13 illustrates an attribute leaf wildcard path vector utilized in accordance with an embodiment of the invention.

FIG. 14 illustrates operations to populate a path range index in accordance with an embodiment of the invention.

FIG. 15 illustrates an entry format that may be used with the path range index.

FIG. 16 illustrates a path range index that may be used in accordance with an embodiment of the invention.

FIG. 17 illustrates query processing performed in accordance with an embodiment of the invention.

FIG. 18 illustrates query plan formation in accordance with an embodiment of the invention.

FIG. 19 symbolically illustrates sets of documents processed in accordance with an embodiment of the invention.

Like reference numerals refer to corresponding parts throughout the several views of the drawings.

### DETAILED DESCRIPTION OF THE INVENTION

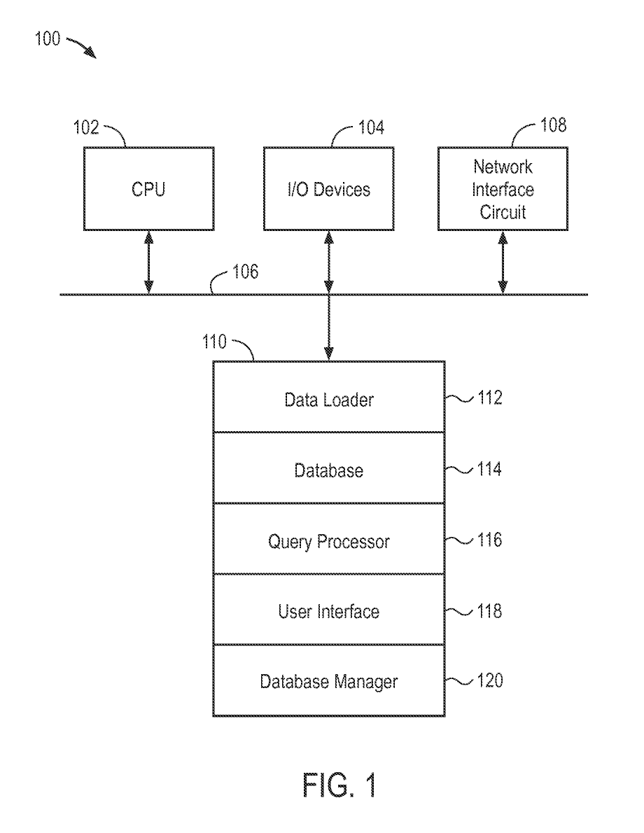

FIG. 1 illustrates a computer 100 configured in accordance with an embodiment of the invention. The computer 100 includes standard components, such as a central processing unit 102 and input/output devices 104 connected via a bus 106. The input/output devices may include a keyboard, mouse, display and the like. A network interface circuit 108 is also connected to the bus 106. Thus, the computer 100 may operate in a networked environment.

A memory 110 is also connected to the bus 106. The memory 110 includes data and executable instructions to implement operations of the invention. A data loader 112 includes executable instructions to process documents and form top-down trees and bottom-up indices, as described herein. These trees and indices are then stored in a tree structured database 114. A query processor 116 includes executable instructions to decompose a query and apply it against the database 114, as discussed below. A user interface 118 includes executable instructions to define an interface to coordinate operations of the invention. A database manager 120 includes executable instructions to perform various database management operations.

The modules in memory 110 are exemplary. These modules may be combined or be reduced into additional modules. The modules may be implemented on any number of machines in a networked environment. It is the operations of the invention that are significant, not the particular architecture by which the operations are implemented.

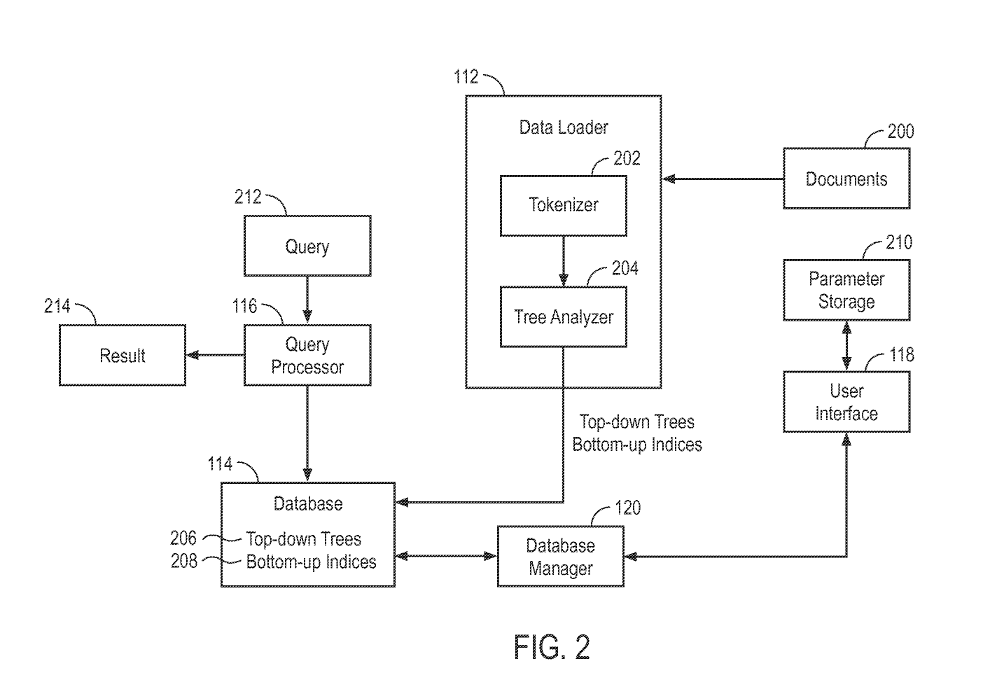

FIG. 2 illustrates interactions between components used to implement an embodiment of the invention. Documents 200 are delivered to the data loader 112. The data loader 112 may include a tokenizer 202, which includes executable instructions to produce tokens or segments for components in each document. A tree analyzer 204 includes executable instructions to form trees with the tokens and then analyze the trees. The tree analyzer forms a top-down tree for each document. The top-down tree characterizes the structure of a document from a root node through a set of fanned out nodes. The tree analyzer also develops a set of bottom-up indices. In particular, bottom-up indices are formed to characterize paths from selected leaf nodes to a root node of a top-down tree. The resultant top-down trees 206 and bottom-up indices 208 are separately searchable entities, which are loaded into a tree structured database 114.

While top-down trees have been used in the prior art to support various search mechanisms, the disclosed technology supplements such top-down trees with the bottom-up indices, which may be conveniently formulated while producing the top-down trees. As demonstrated below, the bottom-up indices allow one to reduce the amount of searched content during query processing. In particular, a match at a leaf node allows one to follow a path to a root node. That is, the path from a leaf node to a root node is a deterministic path up a tree structure. Utilization of the bottom-up indices allows one to limit a search to the relevant segments of a tree structure.

FIG. 2 also illustrates parameter storage 210. Parameter storage 210 stores path parameters for documents stored in the database 114. These path parameters may be used to define various levels of granular path expression and control. The path parameters may be expressed as default configuration path parameters defined in a file. Alternately, a user interface 118 may be used to prompt a user for the path parameters. The path parameters may specify absolute, relative and descendant paths. Embodiments of the invention support the expression of wildcard (e.g., don't care) parameters. Other path parameters may include element paths and attribute paths. An element is a logical document component that either begins with a start-tag and ends with a matching end-tag or consists only of an empty-element tag. The characters between the start- and end-tags, if any, are the element's content and may contain markup, including other elements, which are called child elements. An example of an element is <Greeting>Hello, world.</Greeting>. An attribute is a markup construct comprising a name/value pair that exists within a start-tag or empty-element tag. In the following example the element img has two attributes, src and alt: <img src=“madonna.jpg” alt=‘Foligno Madonna, by Raphael’/>. Another example is <step number=“3”>Connect A to B.</step> where the name of the attribute is “number” and the value is “3”. In accordance with an embodiment of the invention, paths may end in elements or attributes.

The path parameters may be expressed relative to the root node or absolute to the root node. Parameter expressions support descendent operators at any depth within a tree. Similarly, wildcards may be in paths at any depth within a tree. Paths may also contain predicates at any depth. Paths may also contain union operators at any depth.

The database manager 120 is responsive to inputs from the user interface 118. The database manager 120 includes executable instructions to coordinate operations associated with the database 114.

FIG. 2 also illustrates a query processor 116, which receives a query 212 and produces a result 214. The query processor 116 parses the query 212 to produce a query plan. The query plan expresses a set of path constraints used to identify information responsive to the query. The path constraints are matched to separately searchable entities of the tree structured database. In particular, the path constraints are matched to top-down trees characterizing path structures for documents and bottom-up indices for nodes of the path structures for the documents, where the bottom-up indices characterize paths from selected leaf nodes to root nodes of the top-down trees.

Embodiments of the invention support the expression of various path constraints including equal-to, greater-than, greater-than-or-equal-to, less-than, less-than-or-equal-to and not-equal to. Path constraints may be specified for each data type. In the case of a string data type, a user specified collation may be defined.

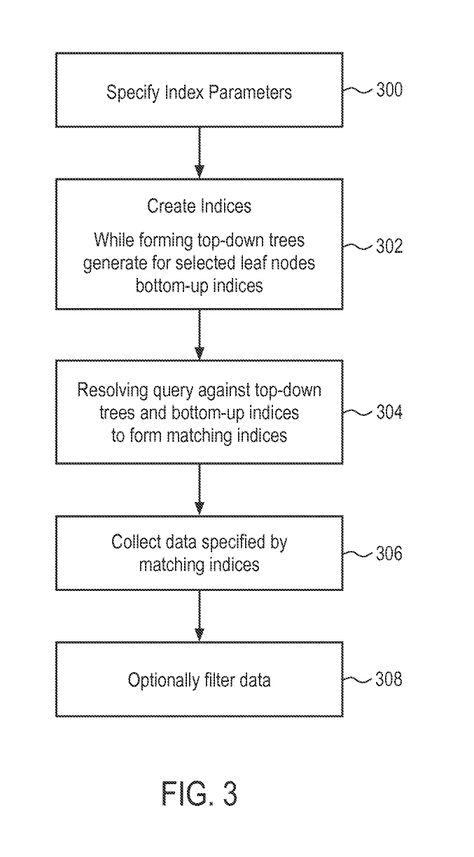

FIG. 3 illustrates processing operations associated with the components of FIG. 2. Initially, index parameters 300 are specified. The index parameters 300 may be specified through the user interface 118 or they may be specified in a default configuration path file. Next, indices are created 302. That it, while forming top-down trees for documents, bottom-up indices are formed for selected leaf nodes of the top-down trees. A query is then resolved against the top-down trees and bottom-up indices to form matching indices 304. Data specified by the matching indices is then collected 306. The resultant data may then be filtered 308.

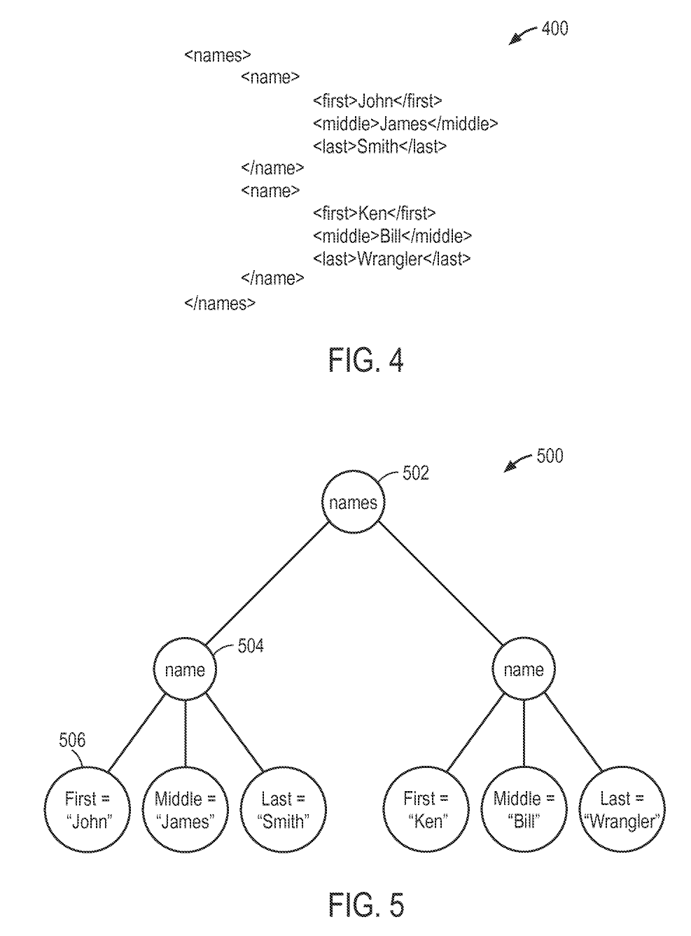

The operations of the invention are more fully appreciated with some specific examples. FIG. 4 illustrates a document 400 that may be processed in accordance with an embodiment of the invention. The document 400 expresses a names structure that supports the definition of various names, including first, middle and last names. A tree structure characterizing this document is shown in FIG. 5. This tree structure naturally expresses parent, child, ancestor, descendent and sibling relationships. In this example, the following relationships exist: “first” is a sibling of “last”, “first” is a child of “name”, “middle is a descendent of “names” and “names” is an ancestor of “middle”.

Various path expressions may be used to query the structure of FIG. 5. For example, a simple path may be defined as /names/name/first. A path with a predicate may be defined as /names/name[middle=“James”]/first. A path with a wildcard may be expressed as /*/name/first, where * represents a wildcard. A path with a descendent may be express as //first.

The indices used in accordance with embodiments of the invention provide summaries of data stored in the database. The indices are used to quickly locate information requested in a query. Typically, indices store keys (e.g., a summary of some part of data) and the location of the corresponding data. When a user queries a database for information, the system initially performs index look-ups based on keys and then accesses the data using locations specified in the index. If there is no suitable index to perform look-ups, then the database system scans the entire data set to find a match. The invention provides bottom-up indices to facilitate search operations. Advantageously, the bottom-up indices are formed while forming top-down tree structures. Consequently, an incremental amount of additional processing provides bottom-up indices that may be effectively used to enhance search operations.

User queries typically have two types of patterns including point searches and range searches. In a point search a user is looking for a particular value, for example, give me last names of people with first-name=“John”. In a range search, a user is searching for a range of values, for example, give me last names of people with first-name>“John” AND first-name<“Pamela”.

Observe that the type of indices required for these two types of queries are different. Point search does not need keys in the index to be stored in a sorted order, but the range index must store sorted values. Database systems usually exploit this subtle difference for efficiently implementing the two types of indices. Range indices contain the entire range of values in a sorted order stored in a data structure that is more suitable for extracting ranges. On the other hand, value indices are stored in structures that are efficient for insertion and retrieval of point value, such as hash tables. A path range index is a collection of sorted values, for example found in an XML document using a user specified path expression. It is useful for queries that search a range of values on a particular path in the database.

The structure 500 of FIG. 5 is a tree representation of the XML document 400 of FIG. 4. A natural way of traversing trees is top-down, where one starts the traversal at the root node 502 and then visits the name node 504 followed by the first node 506. In bottom-up processing, the traversal starts at a selected leaf (e.g., 506) and keeps finding ancestors of each node until it stops at the root 502. Observe that in top-down processing there are many paths to various leaf nodes. However, in bottom-up processing there is only one path from a selected leaf to the root.

A path expression is a branch of a tree. A path expression can be traversed both top-down and bottom-up. Document trees may be traversed at various times, such as when the document gets inserted into the database and after an index look-up has identified the document for filtering. Paths are traversed at various times: (1) when a document is inserted into a database, (2) during index resolution to identify matching indices, (3) during index look-up to identify all the values matching the user specified path range and (4) during filtering. The bottom-up indices of the invention may be utilized during these different path traversal operations.

Top-down traversal can be viewed as forward traversal and bottom-up traversal can be viewed as backward or reverse path traversal. The advantage of top-down traversal is that it is natural and starts with the first node in the document tree or path expression. The database system has to keep track of all the nodes traversed subsequently until the traversal hits a leaf. If there are multiple path indices defined in a system, the system has to traverse all the paths starting at the root to the leaf. This can be very inefficient when there are many paths with large depths. The state of the art implementations of path indices use top-down traversals. They are not only inefficient, but also have a limitation that each path must start from the root of a document. In contrast, the invention uses a combination of top-down document traversal and bottom-up path traversal for efficient document processing. The reverse path traversals are used for index resolution and look-up. This provides high flexibility in path expression syntax and further provides higher performance than top-down path traversal techniques.

Thus, the invention provides bottom-up path traversals at all phases of query processing. This is accomplished through the disclosed data structures used for bottom-up processing. Advantageously, these data structures may be efficiently generated while traversing top-down trees. The structures and techniques of the invention allow for a variety of path operators in queries that use reverse path validation. The path operators may include absolute, relative and descendant paths. Wildcards, union and predicates (relational and existential) may also be used. Further, the disclosed techniques support element and attribute paths.

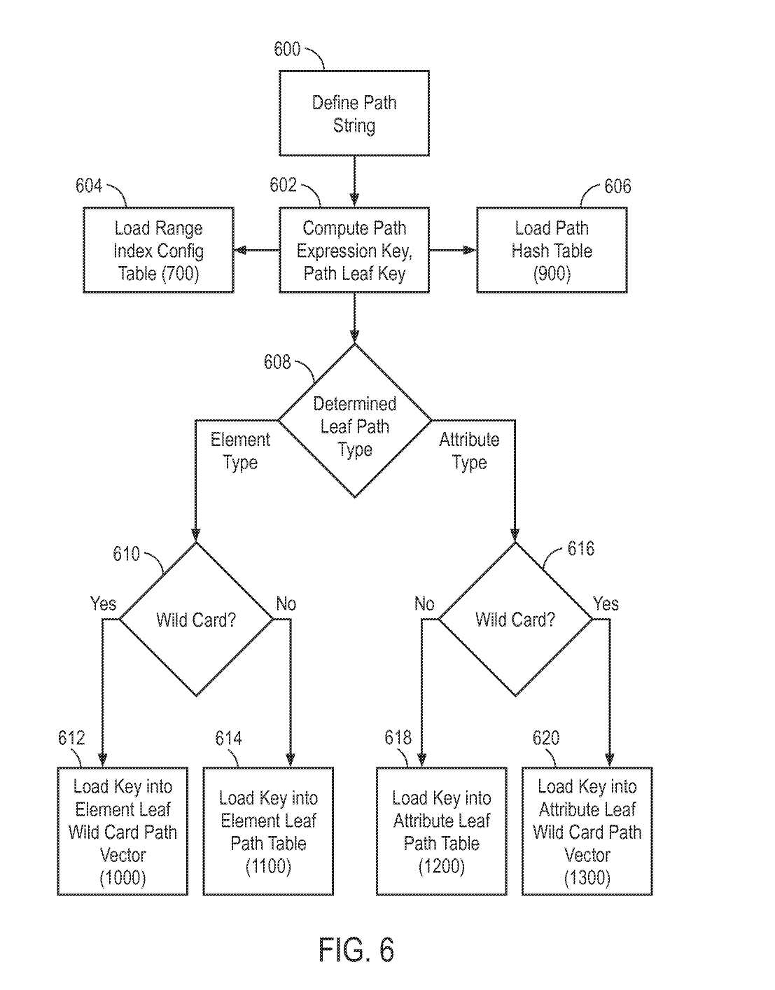

FIG. 6 illustrates operations to form data structures to support operations of the invention. Initially, path strings are defined 600. The path strings are path parameters for a document. They may be expressed at various levels of granularity. The path parameters may be defined in a default configuration path parameter file. Alternately, the path parameters may be defined from prompts at a user interface.

Next, path expression keys and path leaf keys are computed 602. That is, namespaces are resolved into elements and attributes. Keys are computed for individual operators in the parsed tree. Then, an overall path expression key is computed. A leaf key for a path expression may be based on criteria, such as an element, an attribute or a wildcard.

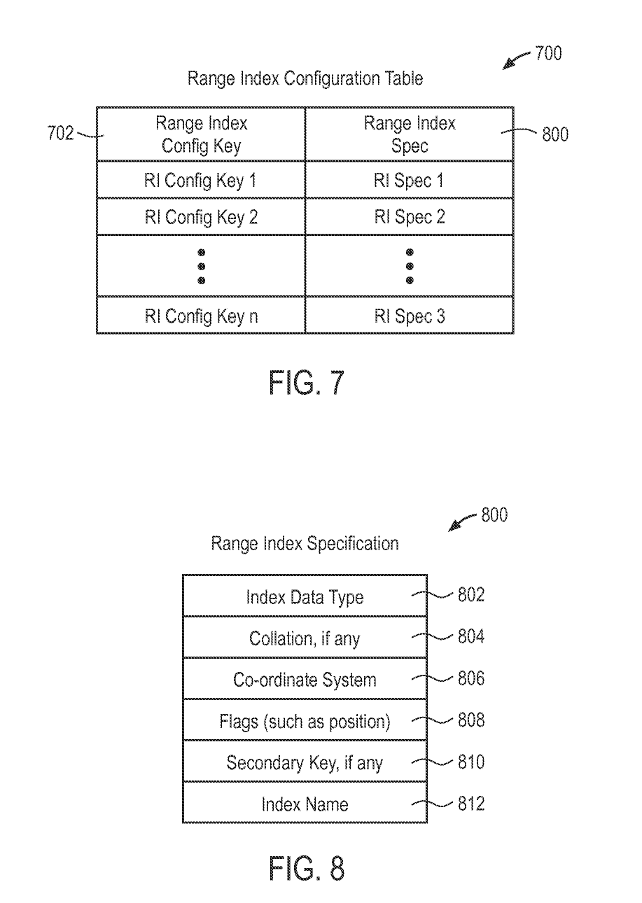

A path expression key may be based on criteria, such as different types of nodes and operators in the path and values of elements and attributess in the path predicates. A range index configuration table is then loaded 604. FIG. 7 illustrates a range index configuration table 700 that may be used in accordance with an embodiment of the invention. In this embodiment, the range index configuration table 700 includes a range index configuration key column 702 and a range index specification column 800. The various rows of the range index configuration key column 702 define different range index configuration keys. Each range index configuration key corresponds to a range index specification. The range index specification 800 defines metadata associated with a range of values.

FIG. 8 illustrates an exemplary range index specification 800, which includes an index data type 802, collation specification, if any 804, a coordinate system 806, flags (such as position flags) 808, a secondary key 810, if any, and an index name 812. The name index 812 may be used as a shorthand reference to an entire index specification. For example, in a query that otherwise requires the specification of a data type, collation and flags, reference to the index name may be used instead of the explicit specification of the multiple elements.

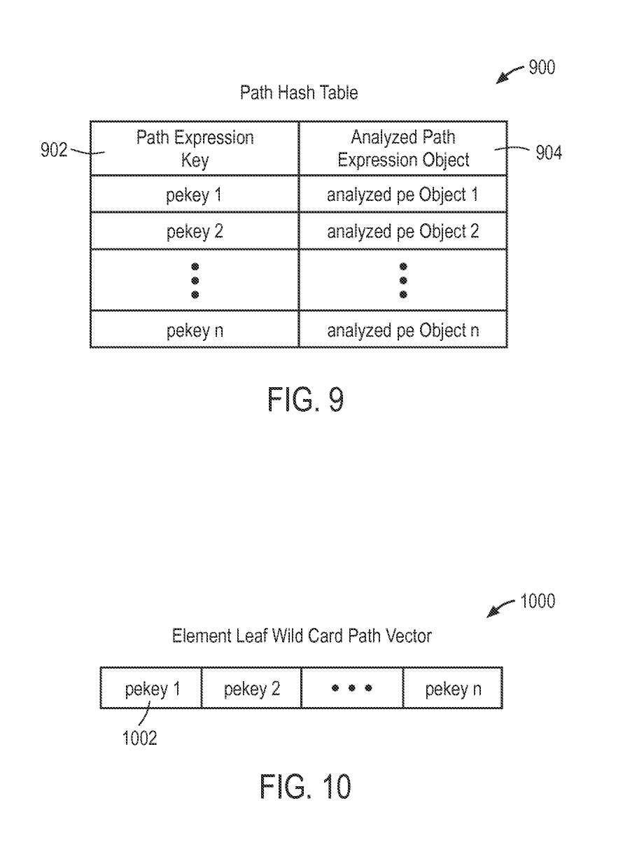

Returning to FIG. 6, a path hash table is loaded 606. FIG. 9 illustrates an example of a path hash table 900. The path hash table 900 includes a path expression key column 902 and an analyzed path expression object column 904.

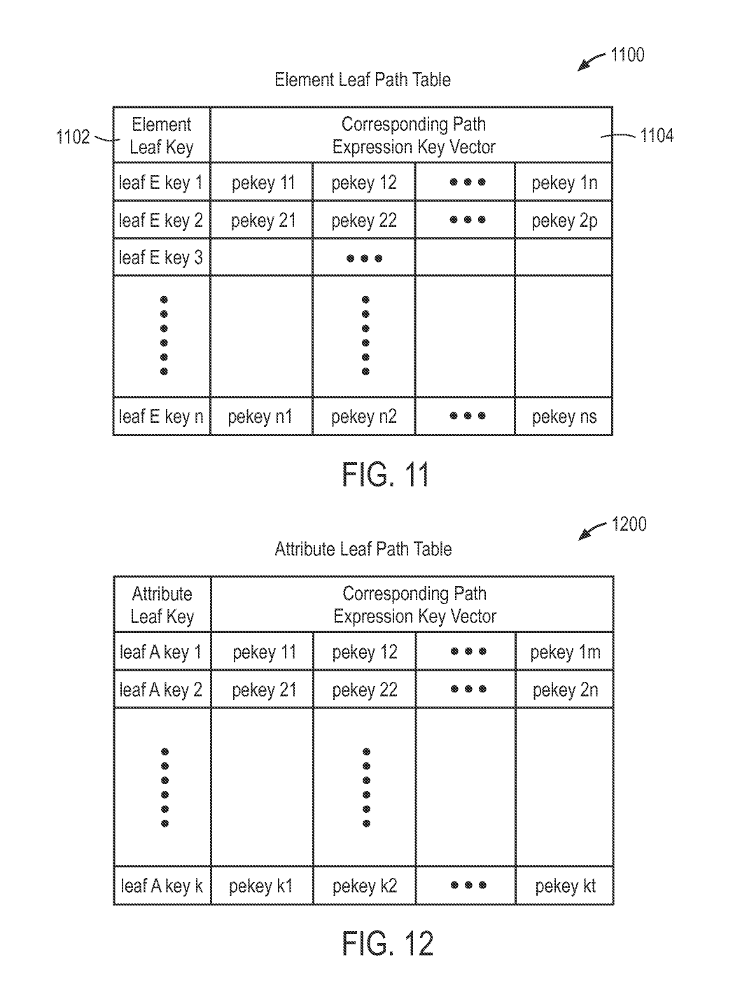

The leaf path type is determined in block 608. If an element type is identified, then it is determined at block 610 if the element is a wildcard. If so (610—Yes), the key is loaded into an element leaf wildcard path vector 612. FIG. 10 illustrates an element leaf wildcard path vector 1000. The element leaf wildcard path vector 1000 includes a variable number of path element keys 1002, in this instance keys pekeyl through pekeyn. If the element type is not a wildcard (610—No), then the key is loaded into an element leaf path table 614. FIG. 11 illustrates an element leaf path table 1100. The element leaf path table 1100 includes an element leaf key column 1102 and a path expression key vector column 1104. A vector in any given row of the path expression key vector column 1104 may have a different length since a variable number of paths may correspond to each leaf key.

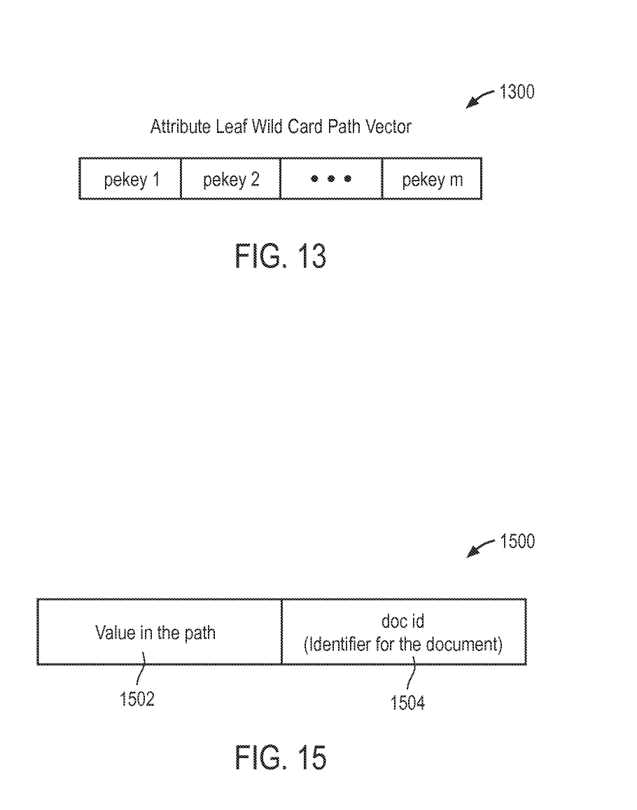

Returning to FIG. 6, if the leaf path type is an attribute, a wildcard determination is made at block 616. If the attribute type is not a wildcard (616—No), the key is loaded into an attribute leaf path table 618. FIG. 12 illustrates an attribute leaf path table 1200, which may be used in accordance with an embodiment of the invention. This table has a structure corresponding to the structure of table 1100. If the attribute type is a wildcard (616—Yes), then the key is loaded into an attribute leaf wildcard path vector 620. FIG. 13 illustrates an attribute leaf wildcard path vector 1300, which has a structure corresponding to vector 1000.

Thus, FIG. 6 illustrates the processing of a path index defined by a user. This results in the formation of various tables that define leaf paths through categories of element type, attribute type and wildcards. These tables may be subsequently used to support bottom-up processing of queries expressed through element type, attribute type or wildcards.

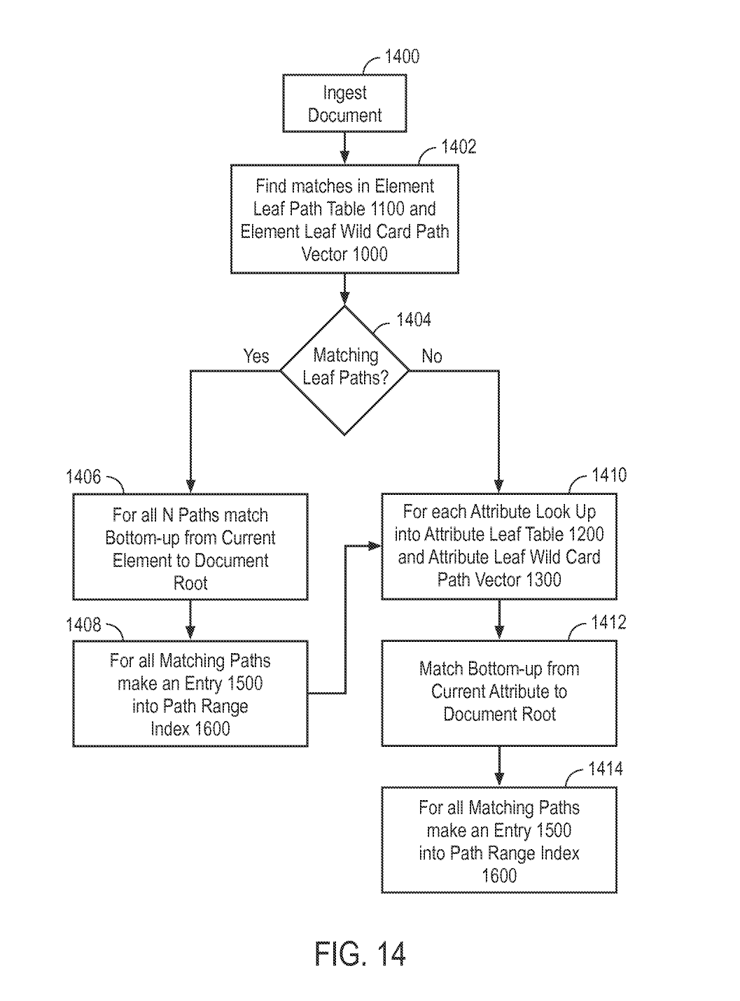

FIG. 14 illustrates operations associated with the categorization of a document with respect to the defined path indices. Initially a document is ingested 1400. The ingestion process results in the formation of a top-down tree characterizing the document. For example, FIG. 4 illustrates a document and its resultant top-down tree characterization is shown in FIG. 5. Leaf nodes in the top-down tree and their associated paths may be identified (e.g., leaf node 506 with bottom-up path to 504 and 502).

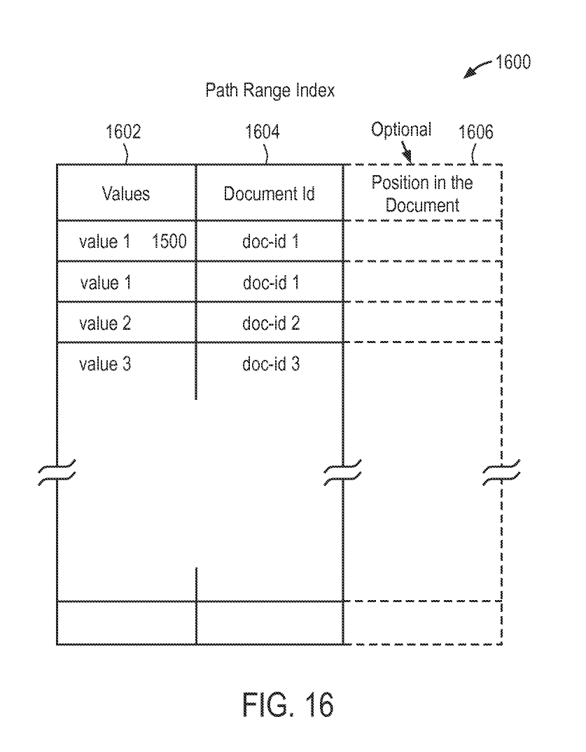

Block 1402 of FIG. 14 illustrates that the identified leaf node paths are then matched to the element leaf path table 1100 and the element leaf wildcard path vector 1000. At block 1404 it is determined whether there are leaf paths matching the leaf key. If so (1404—Yes), all N paths are matched from the bottom-up to the document root 1406. For all matching paths, an entry is made into a path range index 1408. FIG. 15 illustrates an entry 1500 which may be used for this purpose. In this example, the entry 1500 includes a value in the path 1502 and an associated document identification. 1504. FIG. 16 illustrates a path range index 1600 with a value column 1602, a document identification column 1604 and an optional column 1606 for specifying a position in a document. In this example, value 1 appears twice in the document doc-idl and therefore there are two separate entries in the table.

Returning to FIG. 14, processing proceeds to block 1410. For each attribute, there is a lookup into the attribute leaf table 1200 and the attribute leaf wildcard path vector 1300. Thereafter, a match is made from the current attribute to the document root 1412. An entry 1500 is then made into the path range index 1600 for all matching attribute paths 1414. At this point, defined path strings have been associated with paths in the ingested document. The resultant indices define document paths with the specified path strings. Thus, new bottom-up indices are established and may be used for query processing.

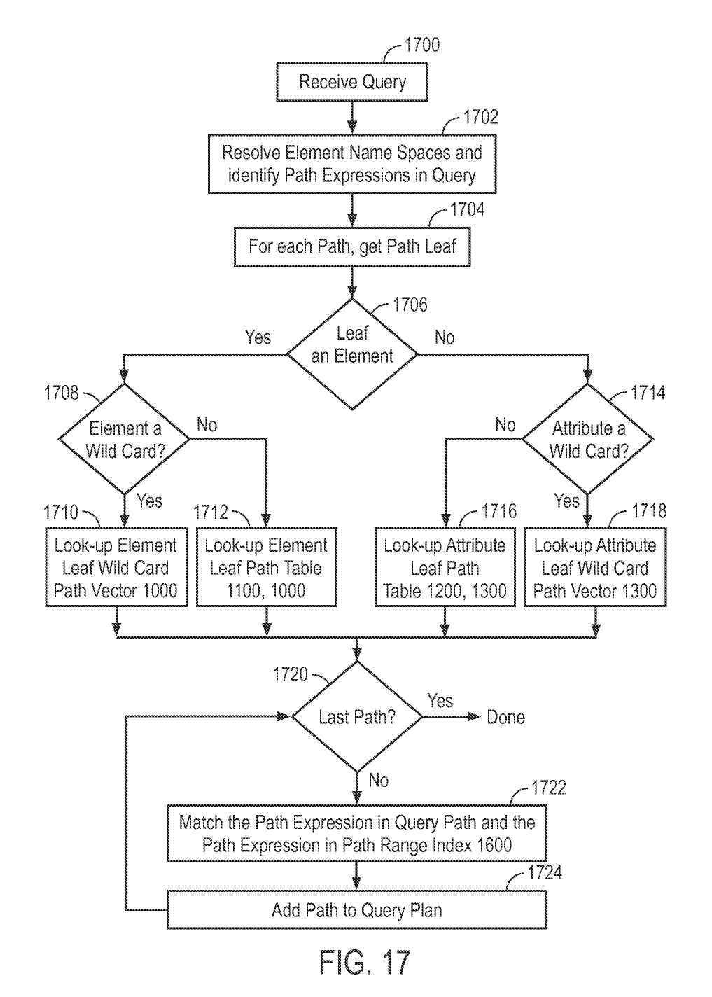

FIG. 17 illustrates query processing performed in accordance with an embodiment of the invention. A query is received 1700. Element name-spaces are resolved and path expressions in the query are identified 1702. For each path, the leaf of the patch is fetched 1704. It is determined whether the leaf is an element 1706. If so (1706—Yes), it is determined whether the element is a wildcard 1708. If so (1708—Yes), a lookup is made to the element leaf wildcard path vector 1000. If not (1708—No), a lookup is made to the element leaf path table 1100 and the element leaf wildcard path vector 1000.

If a leaf is not an element (1706—No), it is determined whether the attribute is a wildcard 1714. If not (1714—No), a lookup is made 1716 to the attribute leaf path table 1200 and attribute leaf wildcard path vector 1300. If so (1714—Yes), a lookup is made 1718 to the attribute leaf wildcard path vector 1300. Processing from blocks 1710, 1712, 1716 and 1718 proceeds to block 1720. If more paths need processing (1720—No), a path expression in the query path is matched to a path expression in the path range index 1722. The matched path is then added to the query plan 1724. This is repeated until the last path is processed (1720—Yes), which terminates processing. Thus, paths in a query are matched to bottom-up path expressions, which may be used to reduce the number evaluated documents.

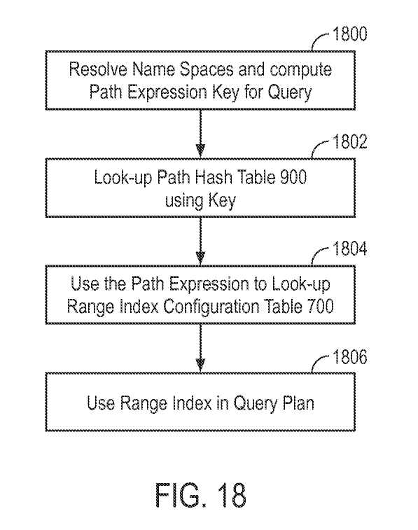

FIG. 18 illustrates query path processing associated with an embodiment of the invention. For any given query, the query processor 116 resolves namespaces and computes a path expression key for the query 1800. The key is used to lookup the path hash table 1802. The path expression is used to lookup the range index configuration table 1804. The range index is then used in the query plan 1806.

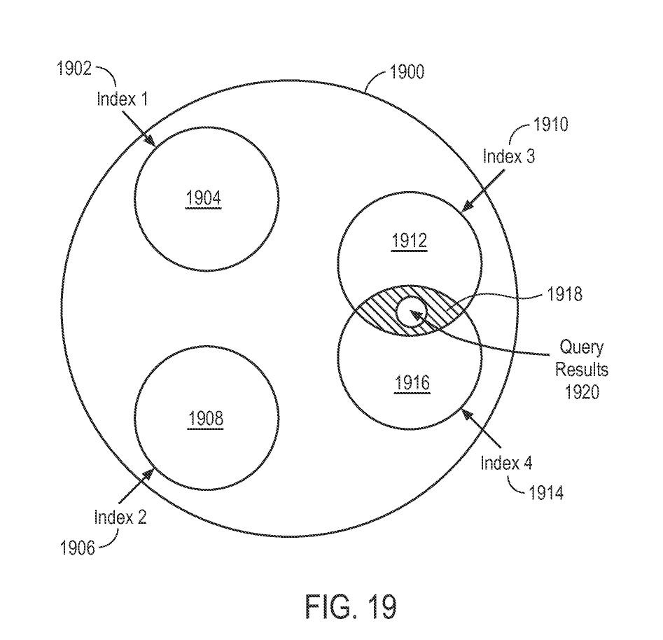

FIG. 19 illustrates efficiencies that are achieved in accordance with the invention. FIG. 19 illustrates a corpus of documents 1900. A first index 1902 points to a first sub-set of documents 1904, while a second index 1906 points to a second sub-set of documents 1908. As shown, the first sub-set of documents 1904 is mutually exclusive from the second sub-set of documents 1908. A third index 1910 points to a third sub-set of documents 1912, which overlaps with a fourth sub-set of documents 1916, which is pointed to by a fourth index 1914. Region 1918 represents the overlapping region. Within the overlapping region 1918 is a set of documents 1920, which constitute query results. That is, documents 1920 are responsive to the query.

The disclosed indices allow a query to be performed which only considers documents 1918. As shown in the figure, this is a small sub-set of all of the documents 1900. Thus, the indices of the invention allow a focused search on a small number of documents. Consequently, data filtering is minimized, if not eliminated. The disclosed query resolution process identifies the set of indices that can produce the smallest set of documents to inspect. The query plan includes the steps to compute the query results. The query plan includes the indices identified through the disclosed index resolution.

The disclosed indexing techniques enable a high-performance query evaluation engine. The query evaluator is capable of using multiple indices in evaluating a single complex query. While each individual index can improve query performance by reducing the amount of data fetched off disk, the query evaluator can aggregate the gains of all indices by composing the use of the indices during a single query evaluation. Therefore, index and query evaluation designs allow the evaluator to use multiple indices at the same time.

The disclosed techniques may be used in connection with geospatial constraints. For example, the system can find all data items that meet a geospatial constraint quickly by using an index to identify and fetch only matching items off disk. For example, a query request all data items that contain the phrase “hello world” and contain a coordinate within 500 miles of latitude 10 degrees and longitude 24 degrees. The full-text index is used in conjunction with a geospatial index.

The indices allow for query evaluation of complex queries. A simple query is a restriction that can be efficiently resolved with a single index. A complex query is a composition of multiple simple queries using Boolean operators, such as AND, OR, AND-NOT. Thus, multiple indices support queries, such as element-value, element-word and geospatial queries.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A method for loading information into a tree structured database, comprising:
receiving a document;
forming a top-down tree characterizing the document;
identifying leaf nodes in the top-down tree;
forming bottom-up indices for the leaf nodes, wherein the bottom-up indices characterizes paths from selected leaf nodes to a root node of the top-down tree; and
storing the top-down tree and bottom-up indices as separately searchable entities in the tree structured database.

2. The method of claim 1 wherein the tree structured database is a markup language database.

3. The method of claim 1 further comprising receiving path parameters for the document.

4. The method of claim 3 wherein receiving includes receiving default configuration path parameters specified in a file.

5. The method of claim 3 wherein receiving includes prompting a user for the path parameters.

6. The method of claim 3 wherein the path parameters include absolute, relative and descendant paths.

7. The method of claim 3 wherein the path parameters include wildcards.

8. The method of claim 3 wherein the path parameters include element paths and attribute paths.

9. The method of claim 3 wherein the path parameters are relative to the root node.

10. The method of claim 3 wherein the path parameters are absolute to the root node.

11. The method of claim 1 further comprising forming a range index configuration table with range index configuration keys and range index specifications.

12. The method of claim 1 further comprising forming a path hash table with path expression keys and analyzed path expression objects.

13. The method of claim 1 further comprising forming an element leaf wildcard path vector, an element leaf path table, an attribute leaf wildcard path vector and an attribute leaf path table.

14. The method of claim 1 further comprising forming a path range index with values and associated document identifications.

15. A method of processing a query to a tree structured database, comprising:
resolving a query to a plurality of path constraints; and
matching the path constraints to separately searchable entities of the tree structured database to form matched paths, wherein the tree structured database includes top-down trees characterizing path structures for documents and bottom-up indices for nodes of the path structures for the documents, wherein the bottom-up indices characterize paths from selected leaf nodes to root nodes of the top-down trees.

16. The method of claim 15 further comprising collecting data associated with the matched paths.

17. The method of claim 16 further comprising filtering the data.

18. The method of claim 15 wherein the path constraints are selected from equal-to, greater-than, greater-than-or-equal-to, less-than, less-than-or-equal-to and not-equal-to.

19. The method of claim 15 wherein the matched paths include matched relative paths to the root nodes and matched absolute paths to the root nodes.

20. The method of claim 15 wherein the matched paths include wildcards.

21. The method of claim 15 wherein the matched paths include matched paths that end in elements and matched paths that end in attributes.

22. The method of claim 15 wherein resolving the query includes processing a name index operative as a substitute for explicitly defined path elements.

23. The method of claim 15 wherein resolving the query includes invoking multiple indices.

24. The method of claim 23 wherein the multiple indices support element-value, element-word and geospatial queries.
